(19) United States
(12) Patent Application Publication
(10) Pub. No.: US 2018/0198682 A1
(43) Pub. Date: Jul. 12, 2018

(54) Strategies for NoC Construction Using Machine Learning

(71) Applicant: NetSpeed Systems, Inc., San Jose, CA (US)

(72) Inventors: Nishant RAO, San Jose, CA (US); Pier Giorgio RAPONI, San Jose, CA (US); Sailesh KUMAR, San Jose, CA (US)

(73) Assignee: NetSpeed Systems, Inc.

(21) Appl. No.: 15/403,162

(22) Filed: Jan. 10, 2017

(51) Int. Cl. H04L 12/24; G06N 99/00; H04L 12/933

(52) U.S. Cl. CPC H04L 41/0886; H04L 49/109; H04L 41/0806; G06N 99/005

(57) ABSTRACT

Aspects of the present disclosure relate to methods, systems, and computer readable mediums for generating/constructing NoC based on one or more strategies that are selected by a machine-learning engine (MLE) from a plurality of available strategies based on an input NoC specification. In an aspect, the method can include the steps of processing a Network on Chip (NoC) specification through a process to generate a vector for a plurality of NoC generation strategies, wherein the vector is indicative of which strategies from the plurality of NoC generation strategies are to be used to generate the NoC to meet a quality metric; and generating the NoC by using the strategies from the plurality of NoC generation strategies indicated by the vector as the strategies to be used to generate the NoC, wherein the process is generated through a machine learning process that is trained for the plurality of NoC generation strategies.

### BACKGROUND

### Technical Field

Aspects of the present disclosure relate to methods, systems, and computer readable mediums for generating/constructing NoC based on one or more strategies that are selected by a machine-learning engine (MLE) from a plurality of available strategies based on an input NoC specification.

### Related Art

The number of components on a chip is rapidly growing due to increasing levels of integration, system complexity and shrinking transistor geometry. Complex System-on-Chips (SoCs) may involve a variety of components e.g., processor cores, Digital Signal Processors (DSPs), hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies 100 in which the routers can connect to one another to create the system network. Bi-directional rings (as shown in FIG. 1(a)), 2-D (two dimensional) mesh (as shown in FIG. 1(b)) and 2-D Taurus (as shown in FIG. 1(c)) are examples of topologies in the related art. Mesh and Taurus can also be extended to 2.5-D (two and half dimensional) or 3-D (three dimensional) organizations. FIG. 1(d) shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has both ports used, one connecting to the router at the top layer and another connecting to the router at the bottom layer. Routers 110 and 112 are at the bottom and top mesh layers respectively, therefore they have only the upper facing port 113 and the lower facing port 114 respectively connected.

Packets are message transport units for intercommunication between various components. Routing involves identifying a path composed of a set of routers and physical links of the network over which packets are sent from a source to a destination. Components are connected to one or multiple ports of one or multiple routers; with each such port having a unique ID. Packets carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2(a) pictorially illustrates an example of XY routing in a two dimensional mesh 200. More specifically, FIG. 2(a) illustrates XY routing from node ‘34’ to node ‘00’. In the example of FIG. 2(a), each component is connected to only one port of one router. A packet is first routed over the x-axis till the packet reaches node ‘04’ where the x-coordinate of the node is the same as the x-coordinate of the destination node. The packet is next routed over the y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there may exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is the header flit, which holds information about this packet's route and key message level info along with payload data and sets up the routing behavior for all subsequent flits associated with the message. Optionally, one or more body flits follows the head flit, containing the remaining payload of data. The final flit is the tail flit, which in addition to containing the last payload also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Taurus NoC, there may exist multiple route paths of equal length or number of hops between any pair of source and destination nodes. For example, in FIG. 2(b), in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3(a) illustrates a two layer NoC 300. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3(b), a host connected to a router from each layer, R1 and R2 respectively, is illustrated. Each router is connected to other routers in its layer using directional ports 301, and is connected to the host using injection and ejection ports 302. A bridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

In a NoC interconnect, if the traffic profile is not uniform and there is a certain amount of heterogeneity (e.g., certain hosts talking to each other more frequently than the others), the interconnect performance may depend on the NoC topology and where various hosts are placed in the topology with respect to each other and to what routers they are connected to. For example, if two hosts talk to each other frequently and require higher bandwidth than other interconnects, then they should be placed next to each other. This will reduce the latency for this communication which thereby reduces the global average latency, as well as reduce the number of router nodes and links over which the higher bandwidth of this communication must be provisioned.

Performance of a NoC design depends on a number of parameters such as area, bandwidth, latency, among others, which may need to be taken into consideration when manually designing an NoC. The manual design of the NoC may be time-consuming and expensive given the number of iterations/changes that are required to be done in order to obtain a design that meets all the required constraints. Also, there may be difficulty in evaluating whether the generated NoC design is optimized to the desired implementation.

### SUMMARY

Example implementations described herein are directed to a system and method that can apply machine learning to process an input NoC specification and automatically construct a NoC meeting the requirements of the specification.

Aspects of the present disclosure relate to methods, systems, and computer readable mediums for generating/constructing NoC based on one or more strategies that are selected by a machine-learning engine (MLE) from a plurality of strategies based on an input NoC specification.

Aspects of the present invention relate to a method that processes a Network on Chip (NoC) specification through a process to generate a vector for a plurality of NoC generation strategies, wherein the vector is indicative of which strategies from the plurality of NoC generation strategies are to be used to generate the NoC to meet a quality metric. The method further generates the NoC by using the strategies from the plurality of NoC generation strategies indicated by the vector as the strategies to be used to generate the NoC, wherein the process is generated through a machine learning process that is trained on the plurality of NoC generation strategies.

In an aspect, the quality metric can be based on at least one of link cost, flop cost, latency, Quality of Service (QoS), area, and bandwidth. In another aspect, the vector can include NoC generation parameters corresponding to each of the strategies from the plurality of NoC generation strategies to be used to generate the NoC. In yet another aspect, the plurality of strategies can include separation of request and response traffic on at least one of different links, different virtual channels, and different layers, and separation of single and multibeat traffic on at least one of different links, different virtual channels, and different layers. Other strategies may also be utilized in accordance with the desired implementation, and the present disclosure is not particularly limited to any set strategy.

In an aspect, method of the present disclosure can further include the step of managing a database of NoCs for each of the plurality of NoC generation strategies and an evaluation for each of the NoCs based on the quality metric, wherein the machine learning process is configured to evaluate the plurality of strategies for the quality metric based on the training for the machine learning conducted on the database of NoCs, and wherein, upon generation of the NoC from the use of the strategies from the plurality of NoC generation strategies, updating the database with the generated NoC and an evaluation of the generated NoC with the quality metric. In an aspect, the quality metric can be selected from a plurality of quality metrics, and wherein the machine learning process is trained for the plurality of quality metrics.

Aspects of the present application may include a computer readable storage medium storing instructions for executing a process. The instructions may involve processing a Network on Chip (NoC) specification through a process to generate a vector for a plurality of NoC generation strategies, wherein the vector is indicative of which strategies from the plurality of NoC generation strategies are to be used to generate the NoC to meet a quality metric. The instructions may further involve generating the NoC by using the strategies from the plurality of NoC generation strategies indicated by the vector as the strategies to be used to generate the NoC, wherein the process is generated through a machine learning process that is trained for the plurality of NoC generation strategies.

Aspects of the present application may further relate to a system comprising a machine learning based NoC construction strategy identification module configured to process an input Network on Chip (NoC) specification through a process to generate a vector for a plurality of NoC generation strategies, wherein the vector is indicative of which strategies from the plurality of NoC generation strategies are to be used to generate the NoC to meet a quality metric, and wherein the process is generated through a machine learning process that is trained for the plurality of NoC generation strategies; and a NoC construction module configured to generate the NoC by using the strategies from the plurality of NoC generation strategies indicated by the vector as the strategies to be used to generate the NoC.

### BRIEF DESCRIPTION OF THE DRAWINGS

FIGS. 1A, 1B, 1C, and 1D illustrate examples of Bidirectional ring, 2D Mesh, 2D Taurus, and 3D Mesh NoC Topologies.

FIG. 2(a) illustrates an example of XY routing in a related art two dimensional mesh.

FIG. 2(b) illustrates three different routes between a source and destination nodes.

FIG. 3(a) illustrates an example of a related art two layer NoC interconnect.

FIG. 3(b) illustrates the related art bridge logic between host and multiple NoC layers.

FIG. 4 illustrates an exemplary architecture showing use of machine learning engine to identify one or more strategies for NoC construction in accordance with an example implementation.

FIG. 5 (a) illustrates an exemplary scenario based on which route types can be selected for each layer in accordance with an example implementation.

FIG. 5 (b) illustrates another embodiment of an exemplary scenario based on which route types can be selected for each layer in accordance with an example implementation.

FIG. 5 (c) illustrates another embodiment of an exemplary scenario based on which route types can be selected for each layer in accordance with an example implementation.

FIG. 6 illustrates an exemplary scenario based on which strategy for minimum arbitration points/losses can be selected in accordance with an example implementation.

FIG. 7 illustrates an exemplary flow diagram in accordance with an example implementation.

FIG. 8 illustrates an exemplary architecture block diagram showing how, based on machine learning based processing of an input NoC specification, one or more strategies can be selected from a plurality of strategies for NoC construction accordance with an embodiment of the present disclosure.

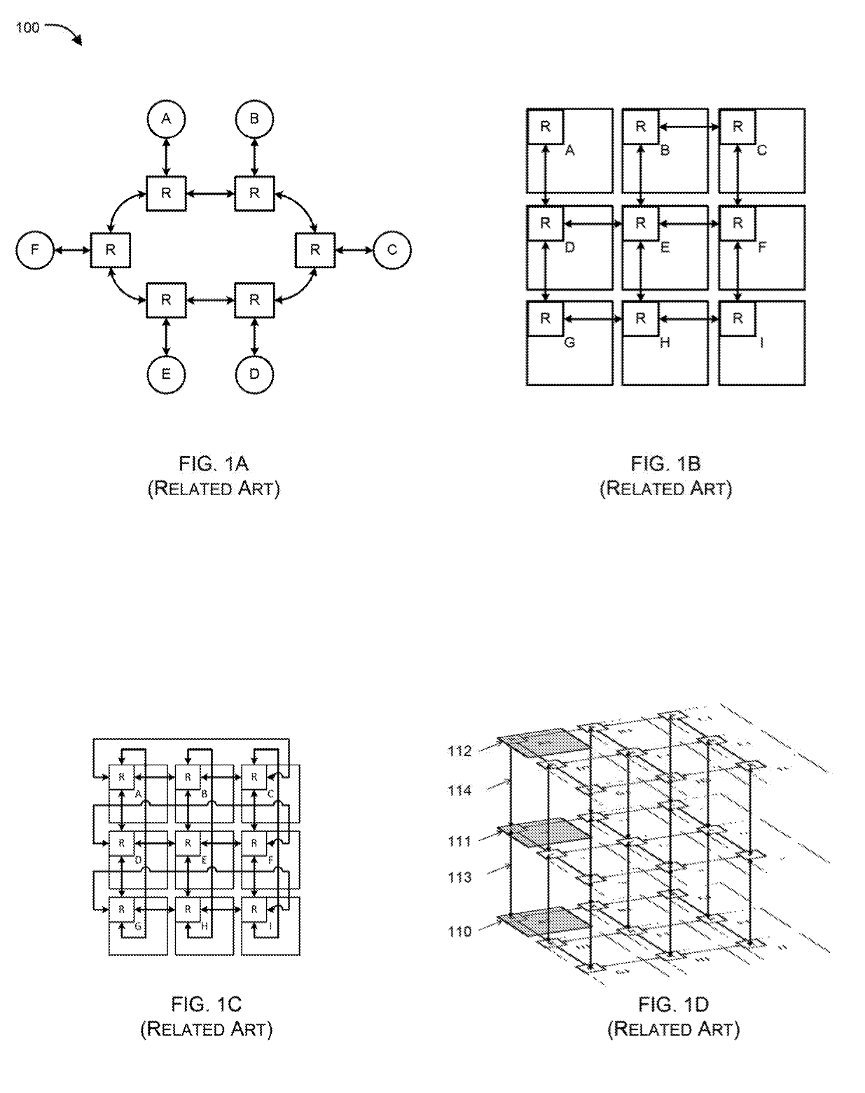

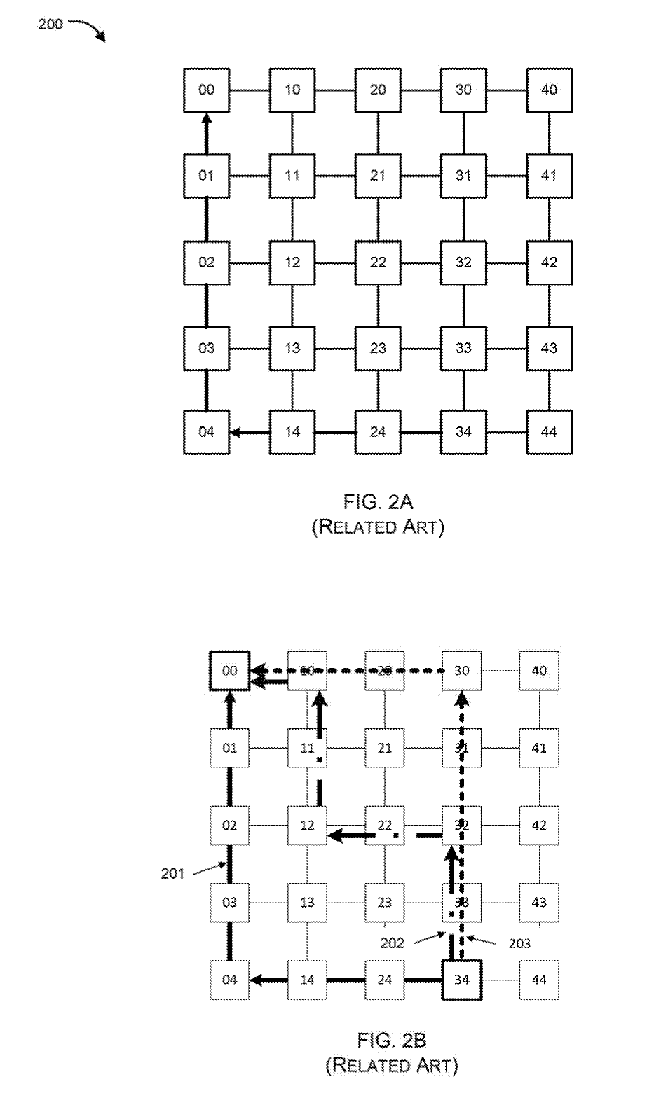

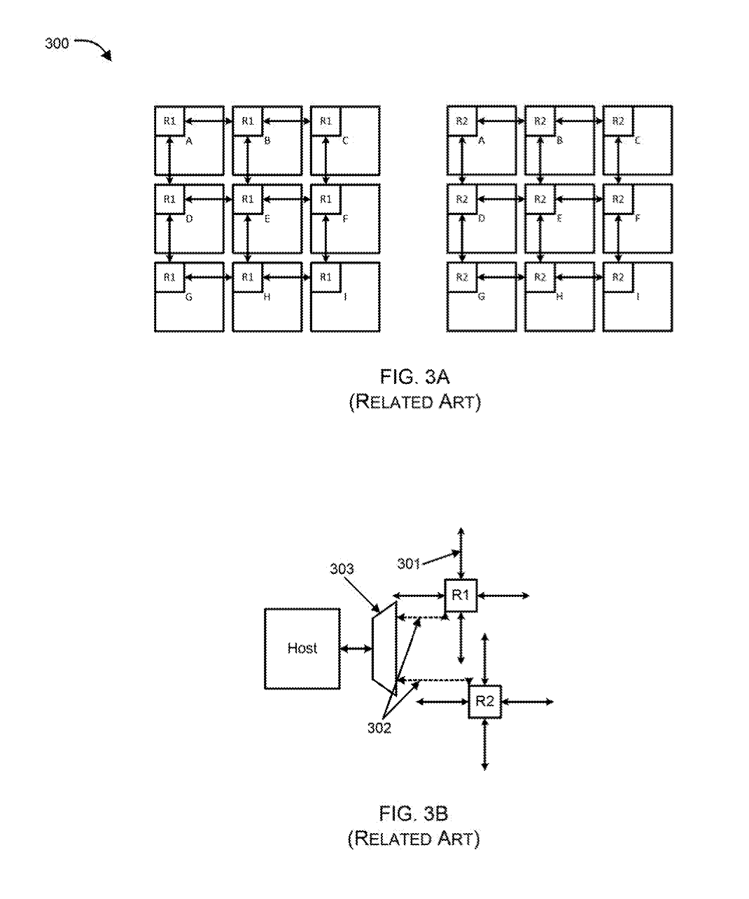

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Example implementations described herein may also be utilized singularly, or in combination with any other example implementation to create the desired implementation.

In example implementations, a NoC interconnect is generated from a specification by utilizing design tools. The specification can contain constraints such as bandwidth/Quality of Service (QoS)/latency attributes that is to be met by the NoC, and can be in various software formats depending on the design tools utilized. Once the NoC is generated through the use of design tools on the specification to meet the specification requirements, the physical architecture can be implemented either by manufacturing a chip layout to facilitate the NoC or by generation of a register transfer level (RTL) for execution on a chip to emulate the generated NoC, depending on the desired implementation. Specifications may be in common power format (CPF), Unified Power Format (UPF), or others according to the desired specification. Specifications can be in the form of traffic specifications indicating the traffic, bandwidth requirements, latency requirements, interconnections and so on depending on the desired implementation. Specifications can also be in the form of power specifications to define power domains, voltage domains, clock domains, and so on, depending on the desired implementation.

Example implementations are directed to the utilization of machine learning based algorithms. In the related art, a wide range of machine learning based algorithms have been applied to image or pattern recognition, such as the recognition of obstacles or traffic signs of other cars, or the categorization of elements based on a specific training. In view of the advancement in power computations, machine learning has become more applicable for the generation of NoCs and for the mapping of traffic flows of NoCs.

Aspects of the present disclosure relate to methods, systems, and computer readable mediums for generating/constructing NoC based on one or more strategies that are selected by a machine-learning engine (MLE) from a plurality of strategies based on an input NoC specification.

Aspects of the present invention relate to a method that processes a Network on Chip (NoC) specification through a process to generate a vector for a plurality of NoC generation strategies, wherein the vector is indicative of which strategies from the plurality of NoC generation strategies are to be used to generate the NoC to meet a quality metric. The method further generates the NoC by using the strategies from the plurality of NoC generation strategies indicated by the vector as the strategies to be used to generate the NoC, wherein the process is generated through a machine learning process that is trained for the plurality of NoC generation strategies.

In an aspect, the quality metric can be based on at least one of link cost, flop cost, latency, QoS, area, and bandwidth. In another aspect, the vector can include NoC generation parameters corresponding to each of the strategies from the plurality of NoC generation strategies to be used to generate the NoC. In yet another aspect, the plurality of strategies can include separation of request and response traffic on at least one of different links, different virtual channels, and different layers, and separation of single and multibeat traffic on at least one of different links, different virtual channels, and different layers.

In an aspect, method of the present disclosure can further include the step of managing a database of NoCs for each of the plurality of NoC generation strategies and an evaluation for each of the NoCs based on the quality metric, wherein the machine learning process is configured to evaluate the plurality of strategies for the quality metric based on the database of NoCs, and wherein, upon generation of the NoC from the use of the strategies from the plurality of NoC generation strategies, updating the database with the generated NoC and an evaluation of the generated NoC with the quality metric. In an aspect, the quality metric can be selected from a plurality of quality metrics, and wherein the machine learning process is trained for the plurality of quality metrics.

Aspects of the present application may include a computer readable storage medium storing instructions for executing a process. The instructions may involve processing a Network on Chip (NoC) specification through a process to generate a vector for a plurality of NoC generation strategies, wherein the vector is indicative of which strategies from the plurality of NoC generation strategies are to be used to generate the NoC to meet a quality metric. The instructions may further involve generating the NoC by using the strategies from the plurality of NoC generation strategies indicated by the vector as the strategies to be used to generate the NoC, wherein the process is generated through a machine learning process that is trained for the plurality of NoC generation strategies.

Aspects of the present application may further relate to a system involving a machine learning based NoC construction strategy identification module configured to process an input Network on Chip (NoC) specification through a process to generate a vector for a plurality of NoC generation strategies, wherein the vector is indicative of which strategies from the plurality of NoC generation strategies are to be used to generate the NoC to meet a quality metric, and wherein the process is generated through a machine learning process that is trained for the plurality of NoC generation strategies; and a NoC construction module configured to generate the NoC by using the strategies from the plurality of NoC generation strategies indicated by the vector as the strategies to be used to generate the NoC.

In an aspect, the present disclosure relates to NoC construction using machine learning. In particular, the present disclosure relates to determining one or more strategies for NoC configuration/construction using machine learning based on traffic characteristics and NoC specification provided by a user. One or more of such strategies may be configured in a manner such that their values are binary i.e. either the strategy is used or is not used for NoC construction. The machine learning implementations of the present disclosure can therefore indicate which of a plurality of strategies should be used for a given NoC specification, and what the values for each of the selected strategies should be in order to construct an optimal NoC based on the input NoC specification.

In an example implementation, a selected one or more strategies can be represented in the form of a bit vector. Alternatively, each of the plurality of identified/possible strategies can be identified and a vector can be created based on respective values thereof. For instance, in an example case involving a total of 17 different strategies, machine learning of the input NoC specification can yield 5 selected strategies having non-zero values, and a vector can be created showing all the 17 strategies, 12 of which may have a value of 0, and the selected 5 strategies can have identified/determined values. The above-proposed representation technique is an example, and any other manner in which strategies can be selected using machine learning is completely within the scope of the present disclosure, depending on the desired implementation.

In an aspect, input NoC specification can be specified in the form of one or more features, which can be processed using machine learning to identify one or more strategies using which NoC can be constructed.

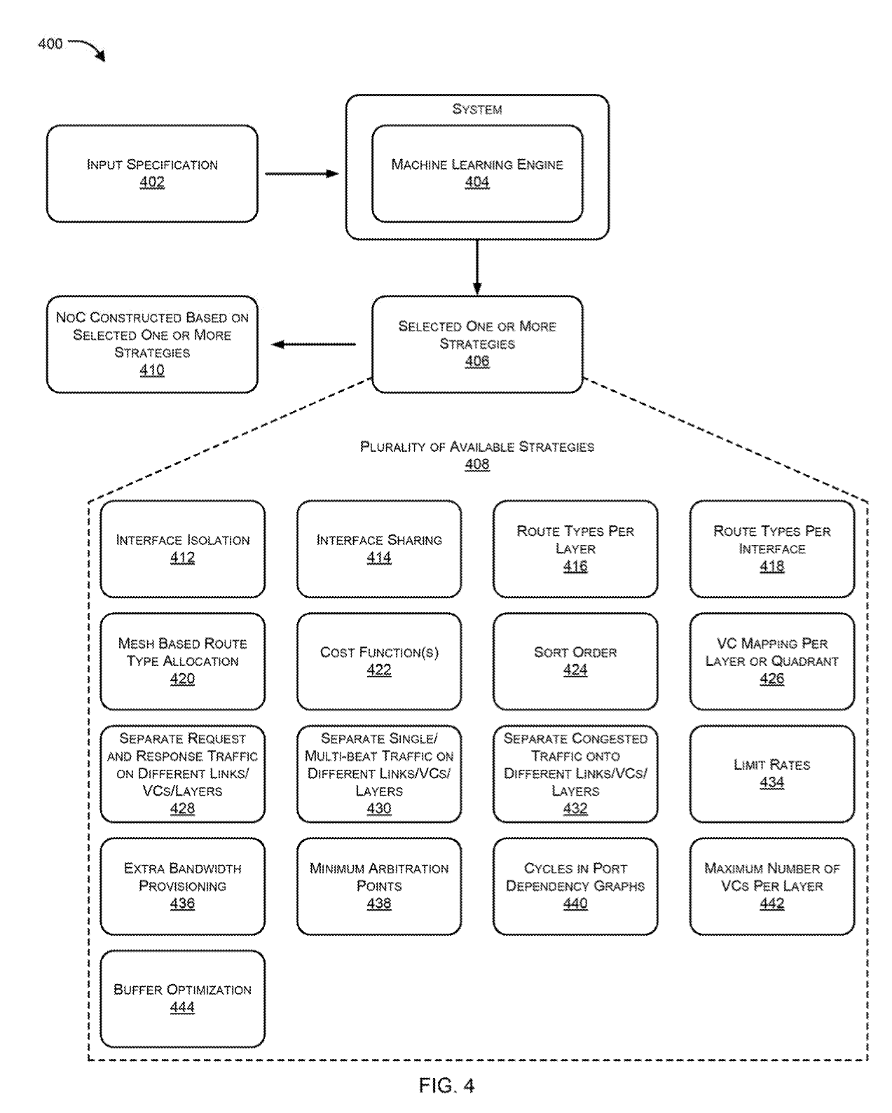

FIG. 4 illustrates an example architecture diagram for NoC construction using machine learning in accordance with an example implementation of the present disclosure. As shown, architecture 400 of the present disclosure can include a machine learning engine (MLE) 404 that can receive a NoC specification 402 from a user as input and process the received NoC specification in order to identify one or more strategies 406 from a plurality of strategies 408 using which the NoC 410 can be constructed.

In an aspect, the one or more strategies 406 can be selected from a plurality of strategies 408 including, but not limited to, interface isolation 412, interface sharing 414, route types per layer 416, route types per interface 418, mesh based route type allocation 420, cost function(s) 422, sort order 424, VC mapping per layer or quadrant 426, separate request and response traffic on different links/VCs/layers 428, separate single/multi-beat traffic on different links/VCs/layers 430, separate congested traffic onto different links/VCs/layers 432, limit rates 434, extra bandwidth provisioning 436, minimum arbitration points 438, cycles in port dependency graphs 440, maximum number of VCs per layer 442, and buffer optimization 444, or a combination thereof.

In an aspect, interface isolation strategy 412 can be configured to indicate where traffic flows should be mapped based on interface/message type (such as read type/write type/snoop type/acknowledgement type/etc.), wherein interface isolation strategy 412 helps map different message types on different layers of a NoC to be constructed so as to create an isolated architecture, which prevents any mixing of message types and helps avoid arbitration losses. With more layers to accommodate more message types, more area may needed on the NoC as additional links and routers are needed in the design. In an example implementation, using the interface isolation strategy 412 there can be, for instance, three layers per interface, all depending on the volume of traffic, wherein the more traffic volume pertaining to a message type, the more layers can be configured for the respective message type/interface. For instance, in case the bandwidth required for read/write interfaces is high, three layers can be configured for each of read/write interfaces, and one layer can be configured for snoop/acknowledgement message types/interfaces. MLE 404 of the present disclosure can therefore, based on the NoC specification indicative of expected traffic, determine the number of total layers required for each interface so as to ensure that each interface (also interchangeably referred to as message type) is independent. The number of layers per interface can also be dynamically changed/configured based on the real-time traffic characteristics.

In an aspect, interface sharing strategy 414, on the other hand, in contrast, enables, for instance, in situations of low bandwidth for one or more message types, sharing of at least one layer by the one or more message types. For instance, as snoop and acknowledgement message types are typically sparse, they can share a set of one or more layers. Therefore, interface sharing strategy 414 can help decide interfaces that can share a given set of layers.

In the examples where both interface isolation strategy 412 as well as interface sharing strategy 414 are used for NoC construction, such examples can be configured such that there is no conflict between the definitions of the respective strategies. For instance, MLE 404 of the present disclosure can ensure that if interface isolation strategy 412 indicates that read interface should be on independent layers, interface sharing strategy 414 cannot output a strategy where the read interface shares a layer with write interface.

In an aspect, sharing of layers can take place at different levels. For instance, in case, in a given NoC layout, a CPU is connected with a cache, which cache is in turn connected with a memory, and NoC specification indicates that CPU to cache traffic is high bandwidth (higher priority), and cache to memory traffic is low bandwidth (lower priority), MLE 404 of the present disclosure can keep messages/traffic between the CPU and the cache at independent layers, and enable sharing of layers for traffic between the cache and the memory. As would be appreciated, any other such configuration/implementation of how layers are to be shared or kept independent for different interfaces is well within the scope of the present disclosure.

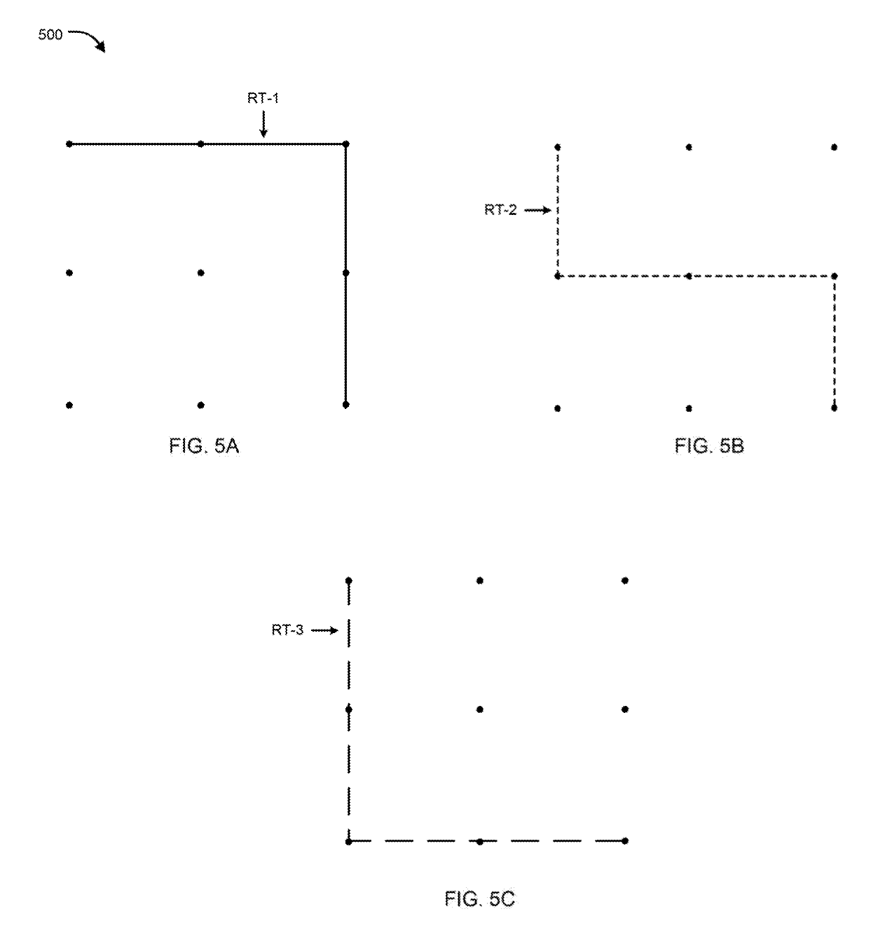

In an aspect, the strategy pertaining to route types per layer 416 can help determine what route types can be configured per layer. For instance, with respect to the examples 500 of FIG. 5, going from start location A to destination location can be done through multiple route types such as RT_1 (bold line), RT_2 (first dotted line), and RT_3 (second dotted line). Such route types therefore depend on the topology, where network elements such as routers are placed, routes that are already mapped on such network elements, among other constraints/rules. MLE 404 of the present disclosure can therefore help determine, given a source and destination, what route types are possible and how optimal each route type is. MLE 404 can further, in another example implementation, decide that all routes on a particular layer need to take a defined route type. For instance, on layer 0, all routes can take route type RT_1, and on layer 1, all routes can take route type RT_2.

In an aspect, the strategy pertaining to route types per interface 418 can facilitate the configuration of NoC such that all reads/first message type/first interface take route type RT_1, and all writes/second message type/second interface take route type RT_2. Therefore, each interface/message type can be configured to choose a defined route type (RT).

In another aspect, strategy pertaining to mesh based route type allocation 420 involves splitting an NoC grid such as a 64*64 mesh into smaller meshes of say 3*3 or 4*4 or 8*8 individual meshes, and mapping of a preferred/desired/defined route type to each individual mesh. In this example, the mesh size may not be a constraint, and any size of mesh can be configured. Further, two or more of a plurality of meshes have the same route type. Therefore a NoC grid can be divided/projected into smaller M*N grids/meshes, and then choose a route decision in such smaller grids/spaces. For instance, a top left corner smaller grid can take route type RT_1 and bottom right smaller grid can take route type RT_2.

In an aspect, a cost function(s) based strategy 422 can be used while constructing/configuring NoC based on what the cost of each routing decision/network element/possible NoC layout is, wherein the cost can, for instance, be based on number of links used, routers used, amount of bandwidth that we are falling short of, length of each route, route type, among other like attributes. Cost function can further indicate the cost of adding each traffic flow to a NoC design. In an aspect, each cost function can be represented by one or more equations, wherein some cost functions are based on area used whereas some others are based on actual cost of implementation/execution/operation. In view of such cost functions, the MLE 404 of the present disclosure can construct the NoC and can also involve a penalty in case additional layers are incorporated in a NoC design that exceed the allowed or scheduled number of layers, or if additional links/routers/turns are configured. The cost function can therefore be used to help user evaluate whether they wish to have more area or bandwidth.

In an example aspect, a sequence in which traffic is to be mapped onto a routing strategy is a parameter for defining the NoC construction. In an aspect, sort order 424 based strategy can be used to sort traffic (by MLE 404) that passes through NoC. For instance, traffic can be sorted based on class, wherein MLE 404 can direct traffic to be mapped such that traffic of QoS-3 is mapped first as its highest priority, and then map traffic on QoS-2, followed by QoS-1 and QoS-0. Another sorting mechanism can be based on rates such that all traffic having high rate (based on say a rate threshold) is mapped first, and piggyback all the low rate traffic on the same. Yet another sorting order can be based on the number of beats, wherein messages (e.g., data) having multiple beats can be mapped first, and messages having a single beat can be mapped subsequently. Any other sorting order such as based on average rate, peak rate, QoS, distance between two points (e.g., sorting longer distances first and then smaller distances), destination bridge type, destination interfaces, source bridge type, source interfaces, number of beats, and congested traffic, is completed within the scope of the present disclosure. Multiple sorting orders can be also be used together such as in a defined sequence. The defined sequence of sorting orders may result in an order that takes several parameters into account instead of single parameter as would be the result of a single sort. Through machine learning implementations, processes can be generated to weigh each sorting order and to implement them in a desired sequence to yield a sort order that takes into account multiple parameters based on their weighting.

In an aspect, a strategy pertaining to VC mapping per layer or quadrant 426 can facilitate an optimal usage of VCs so that the cost can be minimized for a NoC design so as to save additional buffer and area. However, compromising on the number of VC's can impact performance of the NoC design. In various implementations, VCs may need to be incorporated for deadlock avoidance and/or for QoS reasons, and therefore deciding whether and when to add a VC can be considered for NoC construction. In an instance, in a multi-layer NoC architecture, in a section/layer of the NoC where the bandwidth requirement is high, VC re-mapping can be turned off so that the performance is good even if the area is compromised/increased, wherein in a section/quadrant/layer of the NoC where the bandwidth requirement is low, VC re-mapping can be turned on so that the cost can be reduced.

In an aspect, separate request and response traffic on different links/VCs/layers 428 can be configured as part of another strategy, wherein in a typical NoC there is a read request/response packet and a write request/response packet, wherein mixing the packets might not be desired. For instance, A can send read traffic to B, and B sends a response back. Also, B can send read traffic to C, and C sends a response back to B. In such a case, read/command traffic and write/data traffic can interfere, which would not be desired as read request should not block incoming write command. Therefore, in an example implementation, MLE 404 of the present disclosure can separate request packet and response packet on different layers/VC's/links. Therefore, request and response packets can be configured on different layers/links such as they are not mixed, and they are completely isolated. Similarly, as part of strategy 430, single and multi-beat traffic can be configured on different links/VCs/layers. For instance, single beat traffic such as read requests and write responses can be configured on separate layer(s)/link(s)/VC(s) from multi-beat traffic such as read data and write data.

Similar to above, a strategy 432 can be configured to separate congested traffic onto different links/VCs/layers, wherein high rate/bandwidth traffic can be configured on different layers/links from low rate/bandwidth traffic so as to not allow low rate traffic to slow down the high rate traffic.

In an aspect, limit rates 434 based strategy can be configured to limit rates of corresponding interfaces. This strategy can therefore be intended to compute the flit rate of request and response combined together rather than separately. For instance, when the rate of an interface is computed, say when data is received at one flit per cycle, if the read request is a single flit and read data is four flits; read data receive rate is 1 flit/cycle but the read rate is 0.25. In such a situation, links can be sized based on both the request and response combined together rather than separately.

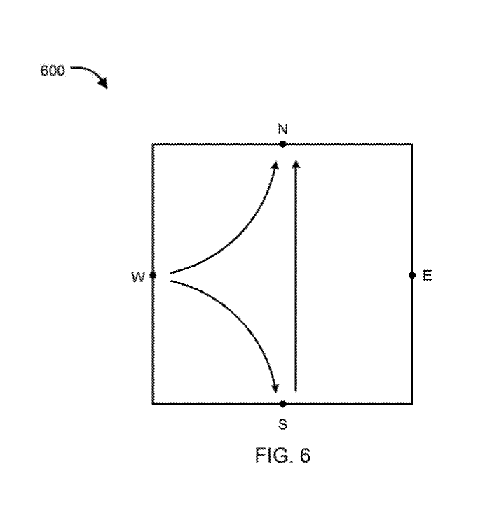

In an aspect, a strategy pertaining to minimum arbitration points/losses 438 relates to ensuring that multiple inputs do not need to wait to feed the same output. For instance, with respect to the example 600 of FIG. 6, in case a first flit is to be sent from west port to south port, a second flit is to be sent from west port to north port, and a third flit is to be sent directly from south port to north port, there would be arbitration losses as there would be an arbitration decision that would need to be taken at north port if the second flit and third flit arrive at the same time. Instead, during such arbitration decision cycle, the first flit that is waiting can be processed to avoid losses.

In an aspect, a strategy pertaining to extra bandwidth provisioning 436 relates to ensuring that the NoC does not face bandwidth/arbitration related losses, even if it involves over-construction of the NoC. For instance, this strategy can be used by dynamically changing allocated bandwidth from say 4 Gbps to 5 Gbps in order to prevent arbitration losses. Such extra bandwidth provisioning can also be performed on a layer-by-layer basis or on a group of layers or on a particular section of the NoC where high bandwidth or fluctuating bandwidth is expected.

In an aspect, a strategy pertaining to cycles in port dependency graphs 440 involves optimal use of virtual channels and routes so as to prevent losses that are caused when, for instance, a router A attempts to send a flit to packet B, but in turn depends on B to send a second flit to do so, which B is not able to send for some reason. In another example, router A may have a slow flit drain rate compared to other routers that it interacts with, thereby causing congestion at A. Any other scenario where loops can be created while transmitting flits can therefore use the intended strategy where routes are defined in a manner such that these loop level losses are prevented.

In an aspect, a strategy pertaining to maximum number of VCs per layer 442 enables limiting of the number of VC's that are allocated to a particular layer, based on, for instance, bandwidth requirement at a particular layer, wherein layers with high bandwidth requirement can be allocated more number of VCs. Similarly, for layers having single QoS traffic (such as acknowledgements), one VC per layer may be sufficient.

In an aspect, a strategy for buffer optimization 444 relates to the reduction of First in First out (FIFO) buffer size to the extent possible to reduce the overall area on the NoC. However, in such an example, based on analysis of the input NoC specification wherein the objective is to increase the performance of the NoC, the buffer size is defined in a manner such that the performance is not compromised irrespective of the area, and therefore the user-defined NoC specification defines how performance vs. area parameters are to be managed.

In an aspect, MLE 404 of the present disclosure can be made to learn strategies (or combinations thereof) and values thereof that are most optimal for each of a plurality of sample NoC specifications, so that when an actual NoC specification is given as input, the MLE 404 can determine parameters from the actual NoC specification, and analyze such parameters to define which strategies should be selected and what the value of each strategy should be. Input NoC specification can also define what the user-expected traffic, quality of NoC, cost, bandwidth requirements are, so that the NoC constructed by the MLE 404 can be assessed to confirm if the NoC meets the defined requirements.

In an aspect, MLE 404 can also be trained to learn what strategies work well on specific NoC design types. MLE 404 can further be configured to run when certain strategies not available or are disabled so as to assess MLE's 404 behavior in such a case. Furthermore, MLE 404 can be configured to allow all possible combination of strategies to run on one or more NoC design types and then for each combination, determine any or a combination of design cost, link cost, cost based on number of flops, latency, QoS, area, bandwidth, among other like parameters to evaluate which combination was most optimal for each NoC design type. Specific quality metrics can also be defined (say in the form of a function) to confirm which strategies or combination thereof worked well for a particular NoC design and which did not, wherein the quality metrics can be devised such that they factor in parameters that are important compared to others, making the quality metrics weighted.

Further, two or more strategies can also be selected in a manner such that no conflicting decision is taken by any two strategies.

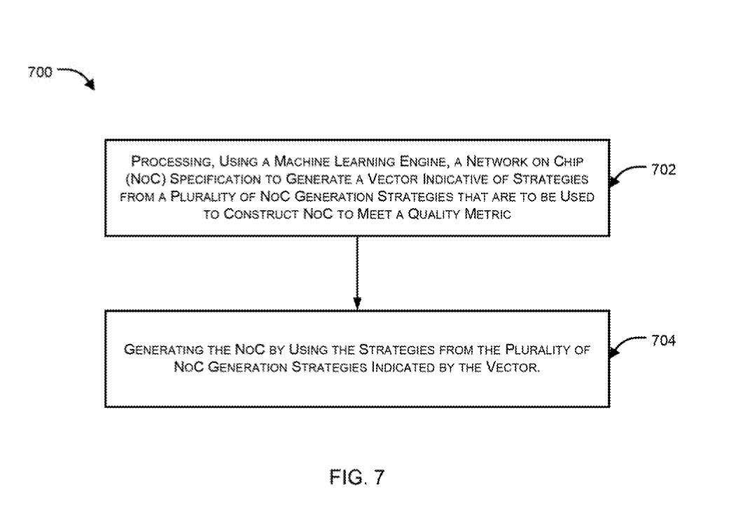

FIG. 7 illustrates an example flow diagram 700 in accordance with an example implementation. At 702, the method of the present disclosure can process a Network on Chip (NoC) specification through a process to generate a vector for a plurality of NoC generation strategies, wherein the vector is indicative of which strategies from the plurality of NoC generation strategies are to be used to generate the NoC to meet a quality metric. At 704, the method can generate the NoC by using the strategies from the plurality of NoC generation strategies indicated by the vector as the strategies to be used to generate the NoC, wherein the process is generated through a machine learning process that is trained for the plurality of NoC generation strategies.

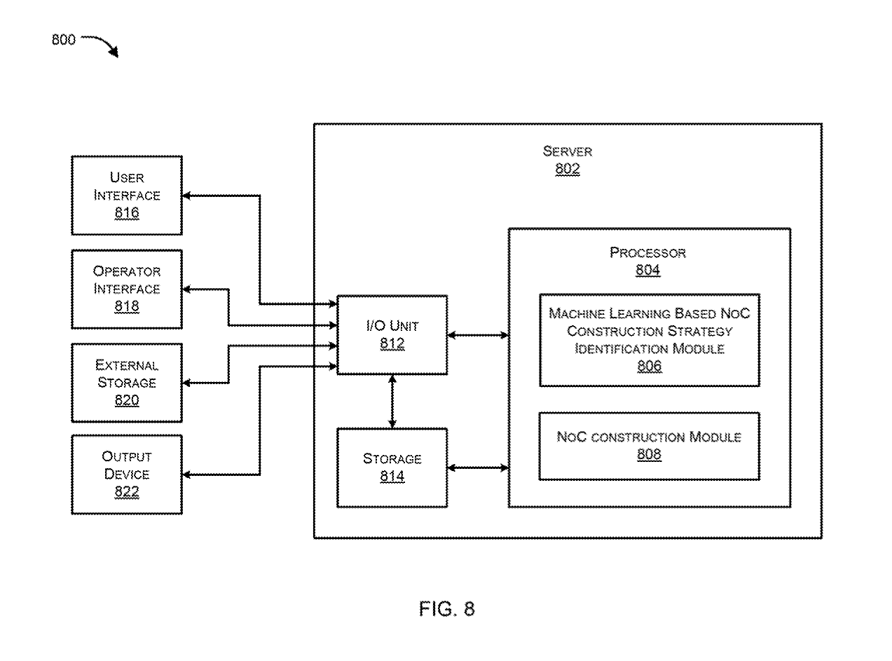

FIG. 8 illustrates an example computer system 800 on which example implementation can be present disclosure can be executed in accordance with an embodiment of the present disclosure. The computer system 800 includes a server 805 which may involve an I/O unit 835, storage 860, and a processor 810 operable to execute one or more units as known to one of skill in the art. The term “computer-readable medium” as used herein refers to any medium that participates in providing instructions to processor 810 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include carrier waves. The I/O unit processes input from user interfaces 840 and operator interfaces 845 which may utilize input devices such as a keyboard, mouse, touch device, or verbal command.

The server 805 may also be connected to an external storage 850, which can contain removable storage such as a portable hard drive, optical media (CD or DVD), disk media or any other medium from which a computer can read executable code. The server may also be connected an output device 855, such as a display to output data and other information to a user, as well as request additional information from a user. The connections from the server 805 to the user interface 840, the operator interface 845, the external storage 850, and the output device 855 may via wireless protocols, such as the 802.11 standards, Bluetooth® or cellular protocols, or via physical transmission media, such as cables or fiber optics. The output device 855 may therefore further act as an input device for interacting with a user.

The processor 810 may execute one or more modules including a machine learning based NoC construction strategy identification module 811 configured to process an input Network on Chip (NoC) specification through a process to generate a vector for a plurality of NoC generation strategies, wherein the vector is indicative of which strategies from the plurality of NoC generation strategies are to be used to generate the NoC to meet a quality metric, and wherein the process is generated through a machine learning process that is trained for the plurality of NoC generation strategies; and a NoC construction module 812 configured to generate the NoC by using the strategies from the plurality of NoC generation strategies indicated by the vector as the strategies to be used to generate the NoC.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present disclosure. Further, some example implementations of the present disclosure may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present disclosure will be apparent to those skilled in the art from consideration of the specification and practice of the teachings of the present disclosure. Various aspects and/or components of the described example implementations may be used singly or in any combination. It is intended that the specification and example implementations be considered as examples only, with the true scope and spirit of the present disclosure being indicated by the following claims.

What is claimed is:

1. A method, comprising:
processing a Network on Chip (NoC) specification through a process to generate a vector for a plurality of NoC generation strategies, wherein the vector is indicative of which strategies from the plurality of NoC generation strategies are to be used to generate the NoC to meet a quality metric; and
generating the NoC by using the strategies from the plurality of NoC generation strategies indicated by the vector as the strategies to be used to generate the NoC, wherein the process is generated through a machine learning process that is trained on the plurality of NoC generation strategies.

2. The method of claim 1, wherein the quality metric is based on at least one of link cost, flop cost, latency, QoS, area, and bandwidth.

3. The method of claim 1, wherein the vector comprises NoC generation parameters corresponding to each of the strategies from the plurality of NoC generation strategies to be used to generate the NoC.

4. The method of claim 1, wherein the plurality of strategies comprises separation of request and response traffic on at least one of different links, different virtual channels, and different layers, and separation of single and multibeat traffic on at least one of different links, different virtual channels, and different layers.

5. The method of claim 1, further comprising:
managing a database of NoCs for each of the plurality of NoC generation strategies and an evaluation for each of the NoCs based on the quality metric;
wherein the machine learning process is configured to evaluate the plurality of strategies for the quality metric based on the database of NoCs;
wherein, upon generation of the NoC from the use of the strategies from the plurality of NoC generation strategies, updating the database with the generated NoC and an evaluation of the generated NoC with the quality metric.

6. The method of claim 1, wherein the quality metric is selected from a plurality of quality metrics, and wherein the machine learning process is trained for the plurality of quality metrics.

7. A non-transitory computer readable medium storing instructions for executing a process, the instructions comprising:
processing a Network on Chip (NoC) specification through a process to generate a vector for a plurality of NoC generation strategies, wherein the vector is indicative of which strategies from the plurality of NoC generation strategies are to be used to generate the NoC to meet a quality metric; and
generating the NoC by using the strategies from the plurality of NoC generation strategies indicated by the vector as the strategies to be used to generate the NoC, wherein the process is generated through a machine learning process that is trained for the plurality of NoC generation strategies.

8. The non-transitory computer readable medium of claim 7, wherein the quality metric is based on at least one of link cost, flop cost, latency, QoS, area, and bandwidth.

9. The non-transitory computer readable medium of claim 7, wherein the vector comprises NoC generation parameters corresponding to each of the strategies from the plurality of NoC generation strategies to be used to generate the NoC.

10. The non-transitory computer readable medium of claim 7, wherein the plurality of strategies comprises separation of request and response traffic on at least one of different links, different virtual channels, and different layers, and separation of single and multibeat traffic on at least one of different links, different virtual channels, and different layers.

11. The non-transitory computer readable medium of claim 7, wherein the instructions further comprise:
managing a database of NoCs for each of the plurality of NoC generation strategies and an evaluation for each of the NoCs based on the quality metric;
wherein the machine learning process is configured to evaluate the plurality of strategies for the quality metric based on the database of NoCs;
wherein, upon generation of the NoC from the use of the strategies from the plurality of NoC generation strategies, updating the database with the generated NoC and an evaluation of the generated NoC with the quality metric.

12. The non-transitory computer readable medium of claim 7, wherein the quality metric is selected from a plurality of quality metrics, and wherein the machine learning process is trained for the plurality of quality metrics.

13. A system comprising:
a machine learning based NoC construction strategy identification module configured to process an input Network on Chip (NoC) specification through a process to generate a vector for a plurality of NoC generation strategies, wherein the vector is indicative of which strategies from the plurality of NoC generation strategies are to be used to generate the NoC to meet a quality metric, and wherein the process is generated through a machine learning process that is trained for the plurality of NoC generation strategies; and
a NoC construction module configured to generate the NoC by using the strategies from the plurality of NoC generation strategies indicated by the vector as the strategies to be used to generate the NoC.

14. The system of claim 13, wherein the quality metric is based on at least one of link cost, flop cost, latency, QoS, area, and bandwidth.

15. The system of claim 13, wherein the vector comprises NoC generation parameters corresponding to each of the strategies from the plurality of NoC generation strategies to be used to generate the NoC.

16. The system of claim 13, wherein the plurality of strategies comprises separation of request and response traffic on at least one of different links, different virtual channels, and different layers, and separation of single and multibeat traffic on at least one of different links, different virtual channels, and different layers.

17. The system of claim 13, wherein the system is configured to manage a database of NoCs for each of the plurality of NoC generation strategies and evaluate each of the NoCs based on the quality metric, wherein the machine learning process is configured to evaluate the plurality of strategies for the quality metric based on the database of NoCs, and wherein, upon generation of the NoC from the use of the strategies from the plurality of NoC generation strategies, the database is updated with the generated NoC and the generated NoC is evaluated with the quality metric.

18. The system of claim 13, wherein the quality metric is selected from a plurality of quality metrics, and wherein the machine learning process is trained for the plurality of quality metrics.
